(19) United States
(12) Patent Application Publication
(10) Pub. No.: US 2018/0205265 A1
(43) Pub. Date: Jul. 19, 2018

(54) WIRELESS POWER TRANSMITTER

(71) Applicant: Samsung Electro-Mechanics Co., Ltd., Suwon-si (KR)

(72) Inventors: Seung Won PARK, Suwon-si (KR); Eun Young SHIN, Suwon-si (KR); Hyo Young KIM, Suwon-si (KR); Ye Ji PARK, Suwon-si (KR)

(73) Assignee: Samsung Electro-Mechanics Co., Ltd., Suwon-si (KR)

(21) Appl. No.: 15/794,784

(22) Filed: Oct. 26, 2017

(30) Foreign Application Priority Data
Jan. 18, 2017 (KR) 10-2017-0008805

(51) Int. Cl. H02J 50/12

(52) U.S. Cl. CPC H02J 50/12; H02M 7/539

(57) ABSTRACT

A wireless power transmitter includes an inverter member comprising transistors configured to convert input power into alternating current (AC) power; a resonating member comprising a capacitor and a coil, and connected to an outer terminal of the inverter member; a controller configured to provide a switching signal to the plurality of transistors to control the inverter member; and a current limiting part configured to limit a level of a current applied to the inverter member by the input power.

### CROSS-REFERENCE TO RELATED APPLICATIONS

This application claims benefit of priority to Korean Patent Application No. 10-2017-0008805 filed on Jan. 18, 2017 in the Korean Intellectual Property Office, the disclosure of which is incorporated herein by reference in its entirety.

### BACKGROUND

### 1. FIELD

The present disclosure relates to a wireless power transmitter.

### 2. DESCRIPTION OF RELATED ART

A wireless power transmitter compares a level of power transmitted by the wireless power transmitter with a level of power received by a wireless power receiver for foreign object detection (FOD). Such a foreign object detection method of comparing the power transmitted by the wireless power transmitter with the power received by the wireless power receiver is performed in a power transfer phase.

In a case in which a wireless power transmitter transmitting power having a low level, such as 5[W], detects a foreign object in the power transfer phase, a temperature increase rate may be low. However, in a case in which a recent wireless power transmitter transmitting power having a medium level, such as 15[W], detects a foreign object in the power transfer phase, since the temperature rapidly increases and the temperature increase rate is high, a user safety issue may result before the foreign object is detected or before a protection mode is entered into according to foreign object detection, and a shape of the wireless power transmitter/receiver may be deformed.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed subject matter.

In one general aspect, a wireless power transmitter includes: an inverter member including transistors configured to convert input power into alternating current (AC) power; a resonating member including a capacitor and a coil, and connected to an outer terminal of the inverter member; a controller configured to provide a switching signal to the plurality of transistors to control the inverter member; and a current limiting part configured to limit a level of a current applied to the inverter member by the input power.

The controller may be configured to determine a quality factor based on a minimum output voltage of the inverter member.

The controller may be configured to determine the quality factor based on a frequency of the switching signal corresponding to a point of time at which the minimum output voltage of the inverter member is detected.

The current limiting part may include a switch and a resistance element connected in parallel and disposed between the input power and the inverter member.

The controller may be configured to determine whether to enter into a power transfer phase based on the quality factor.

The controller may be configured to perform a control so that the switch performs an on-operation during the power transfer phase.

The resonating member may be configured to wirelessly generate power from the AC power during the power transfer phase.

Resistance of the resistance element may be determined based on a voltage of the input power.

In another general aspect, a wireless power transmitter operates by entering one of a plurality of phases according to a state of an external object, and the wireless power transmitter includes: an inverter member including transistors connected to input power in a half-bridge type or a full-bridge type; a resonating member including a capacitor and a coil, and connected to an output terminal of the inverter member; and a current limiting part configured to limit a level of a current applied to the inverter member by the input power during a ping phase of the phases.

The current limiting part may be configured to limit, during the ping phase, the level of the current applied to the inverter member by the input power and provide a reference level of current to the inverter member.

The current limiting part may be configured to transfer, during a power transfer phase of the phases, the current generated by the input power to the inverter member.

The level of the current applied to the inverter member during the ping phase may be lower than the level of the current applied to the inverter member during the power transfer phase.

Switching to the power transfer phase may be performed according to a quality factor detected during the ping phase.

The quality factor may be determined based on a minimum output voltage of the inverter member.

The quality factor may be determined based on a frequency of a switching signal provided to the plurality of transistors at a point of time at which a minimum output voltage of the inverter member is detected.

Either one or both of a type of an external object disposed to be adjacent to the coil and whether or not a center of the coil and the external object are aligned with each other may be determined according to the quality factor.

In another general aspect, a wireless power transmitter includes: an inverter member including transistors, and configured to convert input power into alternating current (AC) power; a resonating member including a capacitor and a coil, and connected to an outer terminal of the inverter member; a current limiting part including a switch and a resistance element connected in parallel, and configured to provide, using the input power, a lower level of current to the inverter member during a ping phase than a level of current provided during a power transfer phrase.

The ping phase may include a quality factor determination phase.

Other features and aspects will be apparent after an understanding of the following detailed description, drawings, and claims.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating an application example of a wireless power transmitter according to an exemplary embodiment in the present disclosure;

FIG. 2 is a flowchart illustrating a method for wirelessly transmitting power according to an exemplary embodiment in the present disclosure;

FIG. 3 is a circuit diagram of the wireless power transmitter according to an exemplary embodiment in the present disclosure; and

FIGS. 4 through 6B are simulation graphs illustrating a minimum output voltage of an inverter member and a frequency of a switching signal corresponding to the minimum output voltage according to a state of the wireless power transmitter according to an exemplary embodiment in the present disclosure.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,”“directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. In addition, the use of the term “may” herein with respect to an example or embodiment, e.g., as to what an example or embodiment may include or implement, means that at least one example or embodiment exists where such a feature is included or implemented while all examples and embodiments are not limited thereto.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, exemplary embodiments of the present disclosure will now be described in detail with reference to the accompanying drawings.

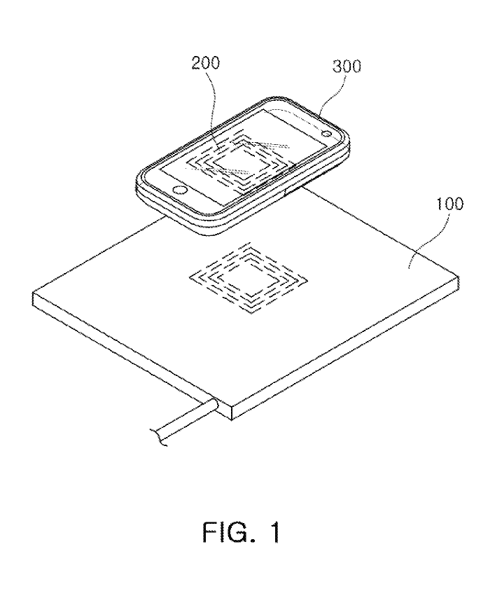

FIG. 1 is a diagram illustrating an application example of a wireless power transmitter according to an exemplary embodiment in the present disclosure.

Referring to FIG. 1, a wireless power receiver 200 disposed to be adjacent to a wireless power transmitter 100 may be magnetically coupled to the wireless power transmitter 100 to thereby wirelessly receive power. As an example, the wireless power transmitter 100 may be magnetically coupled to the wireless power receiver 200 in a magnetic resonance manner and/or a magnetic induction manner.

The wireless power receiver 200 may provide the received power to an electronic device 300. The wireless power receiver 200 may be included as one component in the electronic device 300, or may be a separate component connected to the electronic device 300.

FIG. 1 illustrates that the wireless power receiver 200 is adjacent to the wireless power transmitter 100. Alternatively, no external object is disposed adjacent to the wireless power transmitter 100, or other metal objects other than the wireless power receiver 200 may be disposed to be adjacent to the wireless power transmitter 100. The presence of other metal objects other than the wireless power receiver 200 may affect a charging efficiency between the wireless power transmitter 100 and the wireless power receiver 200. In addition, even in the case in which the wireless power receiver 200 is disposed to be adjacent to the wireless power transmitter 100, charging efficiency may be varied depending on whether or not the wireless power receiver 200 is aligned with a coil of the wireless power transmitter 100. Accordingly, the wireless power transmitter 100 may need to discriminate a kind of the external object disposed to be adjacent thereto and whether or not a transmitting coil and the external object are aligned with each other.

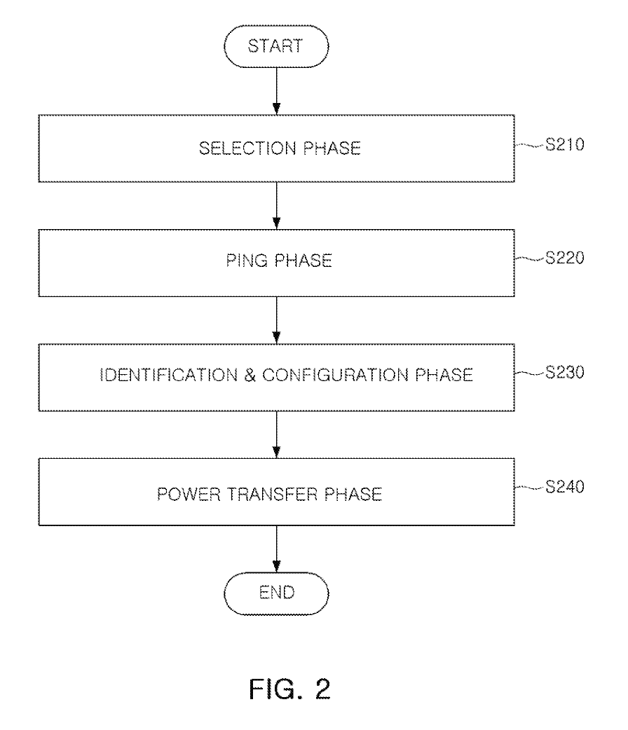

FIG. 2 is a flowchart illustrating a method for wirelessly transmitting power according to an exemplary embodiment in the present disclosure. The method for wirelessly transmitting power according to an exemplary embodiment may be performed by the wireless power transmitter 100. Although the flowchart of FIG. 2 is illustrated in a time sequential order, some orders thereof may be changed and performed, and some phases thereof may be omitted. As an example, the power transfer phase may be performed after a ping phase to be described below.

Referring to FIGS. 1 and 2, the method for wirelessly transmitting power according to an exemplary embodiment may begin with entering a selection phase (S210).

In the selection phase, the wireless power transmitter 100 may transmit a beacon signal. In a case in which an impedance level of the beacon signal which is being transmitted is changed, the wireless power transmitter 100 may determine that an external object is positioned around the wireless power transmitter 100.

In a case in which it is determined that a predetermined external object is adjacent to the wireless power transmitter 100 in the selection phase, the wireless power transmitter 100 may enter the ping phase (S220).

The wireless power transmitter 100 may determine whether or not the external object adjacent to the wireless power transmitter 100 is the wireless power receiver by performing a quality factor (Q-factor) measurement in the ping phase. The wireless power transmitter 100 may discriminate a kind of the external object disposed to be adjacent thereto and whether or not a transmitting coil employed in the wireless power transmitter and the external object are aligned by performing the Q-factor measurement in the ping phase. In a case in which the external object adjacent to the wireless power transmitter 100 is determined to be the wireless power receiver as a result of the Q-factor measurement, the wireless power transmitter 100 may transmit a ping signal.

The wireless power transmitter 100 may enter an identification and configuration phase in response to a response signal of the wireless power receiver for the ping signal (S230).

In a case in which the external object is the wireless power receiver, the wireless power receiver may transmit the response signal for the received ping signal. The response signal of the wireless power receiver may include any one or any combination of any two or more of signal strength information, information on a kind of the wireless power receiver, and information on input voltage strength. Therefore, the wireless power transmitter 100 may identify a target and a power demand using the response signal of the wireless power receiver for the ping signal.

The identification and configuration phase may include a negotiation phase. In the negotiation phase, the wireless power transmitter 100 may transmit a negotiation request signal, and may obtain information on power required by the wireless power receiver as a response of the wireless power receiver for the negotiation request signal. As an example, the power required by the wireless power receiver may be one of low power such as 5[W] and medium power such as 15[W].

The wireless power transmitter 100 may enter the power transfer phase (S240).

The wireless power transmitter 100 may wirelessly provide the power to the wireless power receiver using the information identified in the identification and configuration phase.

In addition, in addition to the above-mentioned phases, a calibration phase of calibrating power loss caused by a foreign object which may be disposed between the wireless power transmitter 100 and the wireless power receiver may be performed by the wireless power transmitter 100. The wireless power transmitter 100 may receive packet information on a load to calibrate the power loss caused by the foreign object. As an example, the packet information on the load may be packet information on a light load and a connected load.

As described above, the wireless power transmitter 100 may determine whether or not the external object adjacent to the wireless power transmitter 100 is the wireless power receiver by performing the quality factor (Q-factor) measurement in the ping phase.

In order to perform the Q-factor measurement, a frequency sweep signal of which a frequency is changed in a predetermined range may be applied to the coil of the wireless power transmitter, and a maximum voltage gain obtained according to the frequency sweep signal and a frequency corresponding to the maximum voltage gain may be used. However, since the Q-factor measurement manner using the maximum voltage gain and the frequency corresponding to the minimum voltage gain needs to include a separate power source having a low voltage level in order to apply the frequency sweep signal of a voltage level which is low enough not to activate the wireless power receiver, there are a problem that a circuit configuration becomes complicated and product cost is increased.

The wireless power transmitter 100 according to an exemplary embodiment may limit a current applied to the inverter member of the wireless power transmitter 100 and may measure Q-factor from the frequency corresponding to a minimum output voltage of the inverter member, in a time section for performing the Q-factor measurement in the ping phase, without including the separate power source.

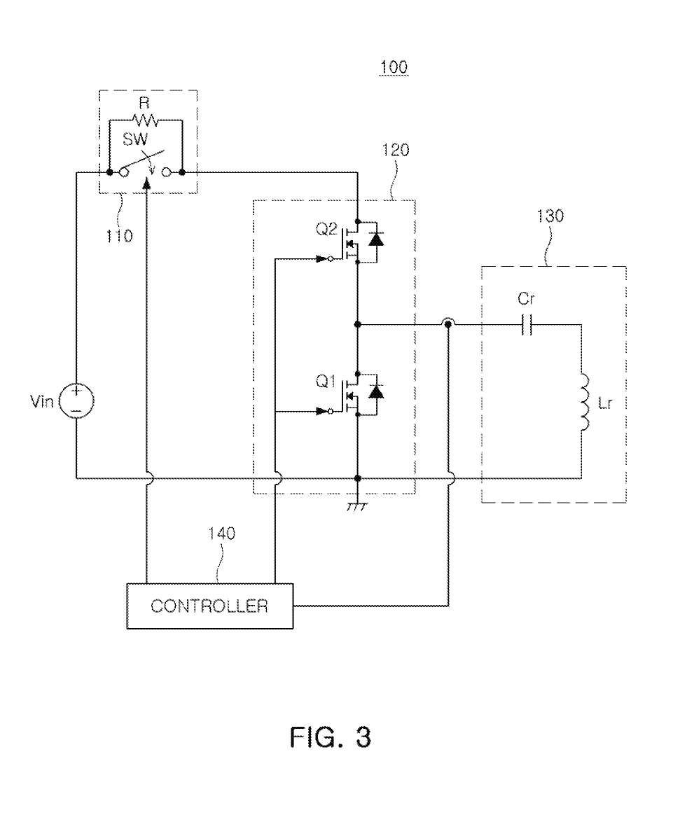

FIG. 3 is a circuit diagram of the wireless power transmitter according to an exemplary embodiment in the present disclosure.

The wireless power transmitter 100 may include a current limiting part 110, an inverter member 120, a resonating member 130, and a controller 140. Input power Vin of the wireless power transmitter 100 may be direct current (DC) power. According to exemplary embodiments, the input power Vin may be alternating current (AC) power, and in this case, the wireless power transmitter 100 may further include an AC-DC converting circuit receiving the AC power and generating the DC power.

The current limiting part 110 disposed between the input power Vin and the inverter member 120 may limit a level of the current applied to the inverter member 120 by the input power Vin in the time section for the Q-factor measurement, and may provide a reference level of current to the inverter member.

The current limiting part 110 may include a resistance element R and a switch SW which are disposed to be in parallel to each other between the input power Vin and the inverter member 120. The switch SW may perform an off-operation in the time section for the Q-factor measurement to limit the level of the current applied to the inverter member 120 by the input power Vin, and perform an on-operation in another time section, particularly, the time section of the power transfer phase, to transfer a current generated by the input power Vin to the inverter member 120. That is, the switch SW may be open during the Q-factor measurement and closed during the power transfer phase.

In this case, the level of the current applied to the inverter member 120 in the time section for the Q-factor measurement may be lower than the level of the current applied to the inverter member 120 in the time section of the power transfer phase. Resistance of the resistance element R may be determined according to a voltage of the input power Vin in order to limit the level of the current applied to the inverter member 120.

The inverter member 120 may include a plurality of transistors Q1 and Q2. The plurality of transistors Q1 and Q2 of the inverter member 120 may alternately perform a switching operation to operate the resonating member 130. The inverter member 120 may be an inverter of a half-bridge type in which two transistors Q1 and Q2 are connected in series with each other as illustrated in FIG. 3. Alternatively, the inverter member 120 may be an inverter of a full-bridge type in which four transistors are connected. The inverter member 120 may be controlled by a fixed frequency manner, a variable frequency manner, a duty-ratio modulation manner, a phase shift manner, and the like.

The resonating member 130 may include a capacitor Cr and a coil Lr which are connected in series with an output terminal of the inverter member 120. A resonance frequency of the resonating member 130 may be determined according to capacitance of the capacitor Cr and inductance of the coil Lr. The resonating member 130 may wirelessly generate power from the AC power transferred from the inverter member 120 in the power transfer phase and transmit the generated power to the outside.

The controller 140 may control a switching operation of the switch SW of the current limiting part 110 and the plurality of transistors Q1 and Q2 of the inverter member 120. The controller 140 may control the plurality of transistors Q1 and Q2 of the inverter member 120 so that the plurality of transistors Q1 and Q2 alternately perform the switching operation by the frequency manner, the variable frequency manner, the duty-rate modulation manner, the phase shift manner, and the like.

The controller 140 may control the switch SW of the current limiting part 110 so that the switch SW performs an off-operation in the time section for the Q-factor measurement to limit the level of the current applied to the inverter member 120 by the input power Vin, and control the switch SW of the current limiting part 110 so that the switch SW performs an on-operation in other time sections, particularly, a time section of the power transfer phase, to transfer a current generated by the input power Vin to the inverter member 120. The controller 140 may control the switch SW to open in response to a determination by the controller 140 to perform Q-factor measurement, and may control the switch SW to close in response to a determination by the controller 140 to terminate the Q-factor measurement and/or perform another operation such as power transfer.

The controller 140 may measure the quality factor according to the output voltage of the inverter member 120 detected in the time section for the Q-factor measurement and frequencies of the switching signals provided to the plurality of transistors Q1 and Q2 of the inverter member 120. According to an exemplary embodiment, the controller 140 may measure the Q-factor from the frequency of the switching signal corresponding to a point of time at which the minimum output voltage of the inverter member 120 is detected.

The controller 140 may determine the kind of the external object adjacent to the wireless power transmitter 100 and whether or not a center of the coil Lr and the external object are aligned with each other according to the quality factor, and determine whether or not the wireless power transmitter 100 enters the wireless power transfer phase.

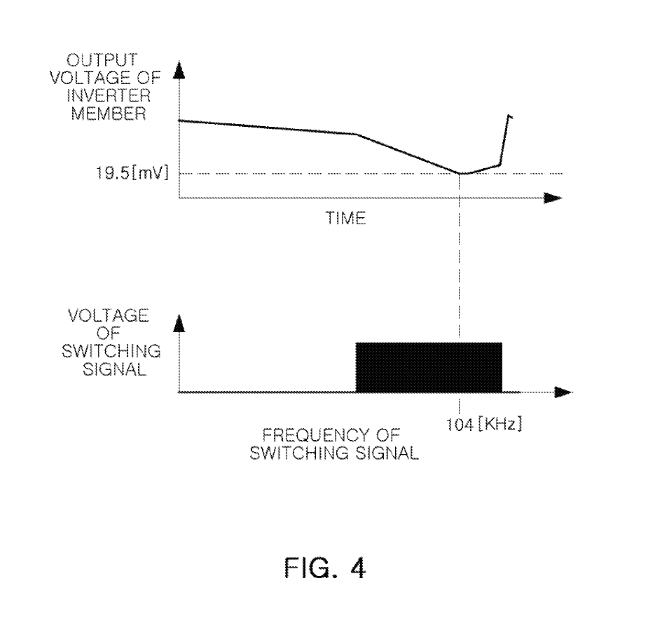

FIGS. 4 through 6B are simulation graphs illustrating a minimum output voltage of an inverter member and a frequency of a switching signal corresponding to the minimum output voltage according to a state of the wireless power transmitter according to an exemplary embodiment in the present disclosure.

FIG. 4 is a simulation graph of a case in which no object is adjacent to the wireless power transmitter. That is, neither a foreign metal object nor the wireless power receiver are adjacent to the wireless power transmitter. Referring to FIG. 4, the minimum output voltage of the inverter member may be 19.5 [mV], and the frequency of the switching signal of the inverter member corresponding to the minimum output voltage of 19.5 [mV] of the inverter member may correspond to about 104 [KHz].

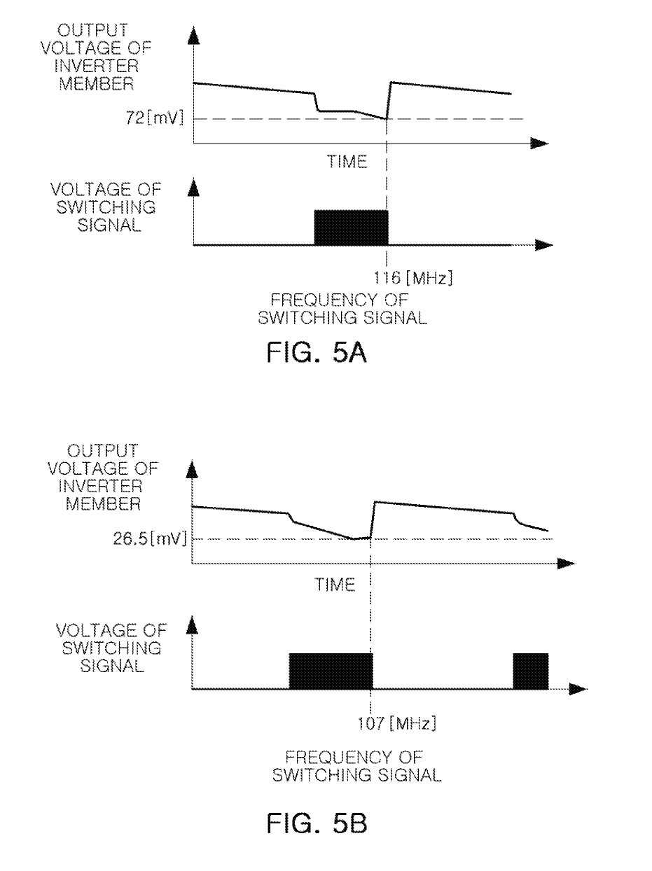

FIGS. 5A and 5B are simulation graphs of a case in which a metal object is adjacent to the wireless power transmitter, wherein the metal object may be a foreign object that is not the wireless power receiver. FIG. 5A is a simulation graph of a case in which the metal object is positioned at the center of the coil of the wireless power transmitter, and FIG. 5B is a simulation graph of a case in which the metal object is positioned to be spaced apart, i.e., off-centered, from the center of the coil of the wireless power transmitter by a predetermined distance.

Referring to FIG. 5A, in the case in which the metal object is positioned at the center of the coil of the wireless power transmitter, a waveform of the minimum output voltage of the inverter member may have a shape which is shifted as the frequency is increased. In this case, the minimum output voltage of the inverter member may be 72 [mV], and the frequency of the switching signal of the inverter member corresponding to the minimum output voltage of 72 [mV] of the inverter member may correspond to about 116 [KHz].

In addition, referring to FIG. 5B, in the case in which the metal object is positioned to be spaced apart from the center of the coil of the wireless power transmitter by a predetermined distance, the minimum output voltage of the inverter member may be 26.5 [mV], and the frequency of the switching signal of the inverter member corresponding to the minimum output voltage of 26.5 [mV] of the inverter member may correspond to about 107 [KHz].

Comparing the frequency of the switching signal the inverter member of FIG. 5A with the frequency of the switching signal of the inverter member of FIG. 4, since impedance of the coil of the wireless power transmitter is changed by the metal object, it may be identified that the frequency of the switching signal of the inverter member of FIG. 5A is higher than the frequency of the switching signal of the inverter member of FIG. 4.

In addition, comparing the frequency of the switching signal of the inverter member of FIG. 5B with the frequency of the switching signal of the inverter member of FIG. 5A, in a case in which the metal object is moved from the center of the wireless power transmitter to an outer portion thereof, it may be identified that the frequency of the switching signal of the inverter member corresponding to the minimum output voltage is lowered, similarly to the result of the case in which no object is adjacent to the wireless power transmitter.

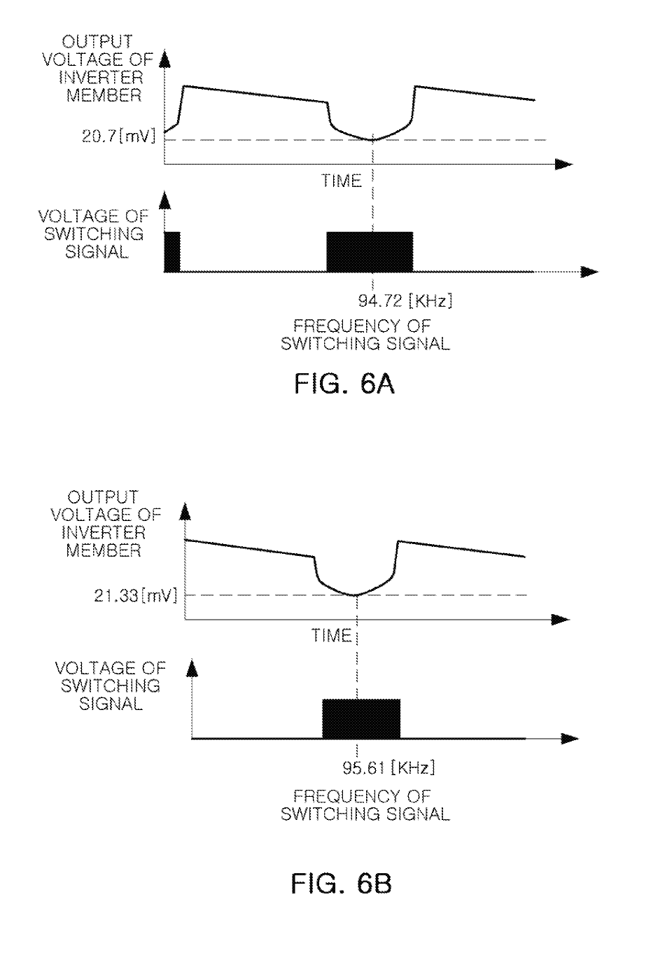

FIGS. 6A and 6B are simulation graphs of a case in which the wireless power receiver is adjacent to the wireless power transmitter, wherein FIG. 6A is a simulation graph of a case in which the wireless power receiver is positioned at the center of the coil of the wireless power transmitter, and FIG. 6B is a simulation graph of a case in which the wireless power receiver is positioned to be spaced apart from the center of the coil of the wireless power transmitter by a predetermined distance.

Referring to FIG. 6A, in the case in which the wireless power receiver is positioned at the center of the coil of the wireless power transmitter, the minimum output voltage of the inverter member may be 20.7 [mV], and the frequency of the switching signal of the inverter member corresponding to the minimum output voltage of 20.7 [mV] of the inverter member may correspond to about 94.72 [KHz].

In addition, referring to FIG. 6B, in the case in which the wireless power receiver is positioned to be spaced apart from the center of the coil of the wireless power transmitter by a predetermined distance, the minimum output voltage of the inverter member may be 21.33 [mV], and the frequency of the switching signal of the inverter member corresponding to the minimum output voltage of 21.33 [mV] of the inverter member may correspond to about 95.61 [KHz].

Table 1 below is a table illustrating results of the simulation graphs of FIGS. 4 through 6B according to an exemplary embodiment and results of a Comparative Example corresponding thereto. In Table 1, Case 1 may correspond to FIG. 4, Case 2 and Case 3 may correspond to FIGS. 5A and 5B, respectively, and Case 4 and Case 5 may correspond to FIGS. 6A and 6B, respectively.

In the Comparative Example, a quality factor may be measured by applying a frequency sweep signal of which a frequency is changed in a predetermined range to the coil of the wireless power transmitter, and using a maximum voltage gain obtained according to the frequency sweep signal and a frequency corresponding to the maximum voltage gain.

TABLE 1

| | Comparative Example | | Inventive Example | |
|---|---|---|---|---|
| | Maximum | | Minimum | Frequency |
| | Voltage [V] | Frequency [KHz] | Voltage [mV] | [KHz] |
| Case 1 | 1.39 | 104 | 19.5 | 104 |
| Case 2 | 0.014 | — | 72.84 | 116.1 |
| Case 3 | 0.67 | 107.53 | 26.5 | 107.9 |
| Case 4 | 1.14 | 94.15 | 20.7 | 94.72 |
| Case 5 | 1.09 | 94.31 | 21.3 | 95.61 |

In the case of Case 2 in Table 1 above, the result in which the frequency of the Comparative Example exceeds 120 [KHz], which is the measured maximum frequency, is derived, where some differences from the Inventive Example in the present disclosure occur. However, referring to the frequencies of Cases 1, and 3 to 5, the Inventive Example in the present disclosure and the Comparative Example derive a similar result, where it may be identified that in the case of the Inventive Example, a precise quality factor may be measured with lowering product cost by removing a separate power source, unlike the Comparative Example.

In addition, referring to Table 1, the wireless power transmitter according to an exemplary embodiment may accurately discriminate or determine the kind of the external object adjacent thereto and whether or not the center of the coil and the external object are aligned with each other, according to the quality factor.

As set forth above, according to the exemplary embodiments in the present disclosure, the foreign object may be detected before the power transfer phase, whereby a safety of a user may be provided, and a deformation of a shape of the wireless power transmitter/receiver may be prevented.

The controller 140 in FIG. 3 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmitter comprising:
an inverter member comprising transistors configured to convert input power into alternating current (AC) power;
a resonating member comprising a capacitor and a coil, and connected to an outer terminal of the inverter member;
a controller configured to provide a switching signal to the plurality of transistors to control the inverter member; and
a current limiting part configured to limit a level of a current applied to the inverter member by the input power.

2. The wireless power transmitter of claim 1, wherein the controller is configured to determine a quality factor based on a minimum output voltage of the inverter member.

3. The wireless power transmitter of claim 2, wherein the controller is configured to determine the quality factor based on a frequency of the switching signal corresponding to a point of time at which the minimum output voltage of the inverter member is detected.

4. The wireless power transmitter of claim 3, wherein the current limiting part comprises a switch and a resistance element connected in parallel and disposed between the input power and the inverter member.

5. The wireless power transmitter of claim 4, wherein the controller is configured to determine whether to enter into a power transfer phase based on the quality factor.

6. The wireless power transmitter of claim 5, wherein the controller is configured to perform a control so that the switch performs an on-operation during the power transfer phase.

7. The wireless power transmitter of claim 6, wherein the resonating member is configured to wirelessly generate power from the AC power during the power transfer phase.

8. The wireless power transmitter of claim 4, wherein resistance of the resistance element is determined based on a voltage of the input power.

9. A wireless power transmitter that operates by entering one of a plurality of phases according to a state of an external object, the wireless power transmitter comprising:
an inverter member comprising transistors connected to input power in a half-bridge type or a full-bridge type;
a resonating member comprising a capacitor and a coil, and connected to an output terminal of the inverter member; and
a current limiting part configured to limit a level of a current applied to the inverter member by the input power during a ping phase of the phases.

10. The wireless power transmitter of claim 9, wherein the current limiting part is configured to limit, during the ping phase, the level of the current applied to the inverter member by the input power and provide a reference level of current to the inverter member.

11. The wireless power transmitter of claim 9, wherein the current limiting part is configured to transfer, during a power transfer phase of the phases, the current generated by the input power to the inverter member.

12. The wireless power transmitter of claim 11, wherein the level of the current applied to the inverter member during the ping phase is lower than the level of the current applied to the inverter member during the power transfer phase.

13. The wireless power transmitter of claim 12, wherein switching to the power transfer phase is performed according to a quality factor detected during the ping phase.

14. The wireless power transmitter of claim 13, wherein the quality factor is determined based on a minimum output voltage of the inverter member.

15. The wireless power transmitter of claim 13, wherein the quality factor is determined based on a frequency of a switching signal provided to the plurality of transistors at a point of time at which a minimum output voltage of the inverter member is detected.

16. The wireless power transmitter of claim 13, wherein either one or both of a type of an external object disposed to be adjacent to the coil and whether or not a center of the coil and the external object are aligned with each other is determined according to the quality factor.

17. A wireless power transmitter comprising:
an inverter member comprising transistors, and configured to convert input power into alternating current (AC) power;
a resonating member comprising a capacitor and a coil, and connected to an outer terminal of the inverter member;
a current limiting part comprising a switch and a resistance element connected in parallel, and configured to provide, using the input power, a lower level of current to the inverter member during a ping phase than a level of current provided during a power transfer phrase.

18. The wireless power transmitter of claim 17, wherein the ping phase comprises a quality factor determination phase.
